(19) United States
(12) Patent Application Publication
(10) Pub. No.: US 2013/0302753 A1
(43) Pub. Date: Nov. 14, 2013

(54) SPRING CLIP MOUNTED TO WITHDRAWABLE ARTIFICIAL TOOTH AND REMOVABLE ARTIFICIAL TOOTH ASSEMBLED WITH SAME

(71) Applicants: TAI-WU LIN, Taipei City (TW); YEN-TING LIN, Taipei City (TW)

(72) Inventors: TAI-WU LIN, Taipei City (TW); YEN-TING LIN, Taipei City (TW)

(21) Appl. No.: 13/598,571

(22) Filed: Aug. 29, 2012

(30) Foreign Application Priority Data
May 9, 2012 (TW) 101208761
Jun. 12, 2012 (TW) 101211268

(51) Int. Cl. A61C 13/271

(52) U.S. Cl. 433/178

(57) ABSTRACT

The present invention provides a spring clip mountable to a withdrawable artificial tooth and a removable artificial tooth that is assembled through the spring clip. The spring clip mounted to the withdrawable artificial tooth can clamp a projection block formed on a corresponding internal crown or a neighboring tooth to allow the external crown to be removed by direct application of force to the external crown thereby allowing a user to easily remove the artificial tooth (the external crown) for cleaning.

### TECHNICAL FIELD OF THE INVENTION

The present invention generally relates to a spring clip for withdrawable artificial teeth and a removable artificial tooth assembled with the spring clip.

### DESCRIPTION OF THE PRIOR ART

Generally speaking, when a tooth is severely decayed or is cracked by an external force, to maintain the masticatory capability and aesthetics, a dental brace is attached to natural teeth that have subjected to treatment. A drawback of such a treatment is that debris of food and corrosion may get accumulated in the gingival sulcus between the gums and the brace. Such debris cannot be completely removed with the general daily cleaning operation and may lead to rotting of the debris and corrosion inside the gingival sulcus. Bacteria or toxicants may be generated to attack the surrounding tissues of tooth roots, gums, and periodontal bone and the patient may need a more intense treatment in the future.

A removable artificial tooth that was developed in Germany comprises internal and external crowns. The internal crown is mounted to a natural toot and the external crown is attached to the internal crown. In the way, the external crown can be removed for cleaning and at the same time, the food debris accumulated between the internal crown and the gums can be cleaned off to thereby avoid the issue of periodontitis. Such a removable artificial tooth is fixed by the frictional force induced between the surfaces of internal and external crowns and thus allows of direct removal of the external crown for cleaning. When the external crown is worn out or unexpectedly damaged, the external crown can be repaired independently. However, it is disadvantageous that the mounting stability of the external crown is poor. Since the internal and external crowns are fixed through the frictional force therebetween, in case the frictional force is small, the external crown is susceptible to easy detachment due to being stuck to sticky foodstuffs in chewing the foodstuff. On the other hand, in case the frictional force between the internal and external crowns is excessively large, the external crown may get stuck and cannot be removed.

### SUMMARY OF THE INVENTION

In order to overcome the issue of coupling between internal and external crowns, the present invention provides a spring clip mountable to a withdrawable artificial tooth and a removable artificial tooth that is coupled through the spring clip. The spring clip of the present invention allows a user to easily mount and remove an artificial tooth (the external crown) and particularly, an effect of positioning assistance can be realized when the external crown is set to a predetermined position so as to improve the easiness of use.

To achieve the above object, the present invention provides a spring clip mountable to a withdrawable artificial tooth for clamping a projection block formed on an internal crown. The spring clip comprises a first spring arm and a second spring arm. The first spring arm has an end forming a first fixed end and an opposite end forming a first movable end, wherein the first fixed end is fixed inside an external crown. The second spring arm has an end forming a second fixed end and an opposite end forming a second movable end, wherein the second fixed end is fixed inside the external crown. The first movable end and the second movable end are spaced from each other by a distance that is less than width of the projection block, whereby when the external crown is pressed down to fit over the internal crown, the first movable end and the second movable end are expanded outward by the projection block to allow the projection block to get into the space between the first spring arm and the second spring arm.

A further advantage of the present invention is that arrangement of first and second necks allow the relative position of the projection block and the spring clip to be more stable.

Further, another advantage of the present invention is to form the first and second movable ends by inward curving so as to allow the relative movement thereof relative to the projection block to be made in a smooth manner.

Further, another advantage of the present invention is to provide a structure that allows relative movements of the first and second movable ends with respect to the projection block in a smooth manner and comprises a curve formed between the first movable end and the first neck and a curve also formed between the second movable end and the second neck, whereby openings of the two curves are set opposing each other to allow the projection block that passes through the first movable end and the second movable end to enter a space formed between the two opposing curves.

Further, it may be further arranged that the first fixed end and the second fixed end are connected to each other.

Further, in an embodiment, the first spring aim is linear and a second neck is formed between the second fixed end and the second movable end. The second neck and the first spring aim are spaced from each other by a distance that is less than size of the projection block to prohibit the projection block from expanding the first and second necks. A curve is formed between the second movable end and the second neck. The curve has an opening that opposes the first spring arm. Further, the second movable end is formed by inward curving the second spring arm. As such, the purpose of the present invention is achieved.

Further, in an embodiment, the first movable end is formed by inward bending the first spring arm twice, each bending being made by an angle less than 90 degree and greater than 0 degree. The second movable end is made opposite to the first movable end and is formed by inward bending the second spring arm twice with each bending being made by an angle less than 90 degrees and greater than 0 degree. One of the bends of the first spring arm is made abutting against one of the bends of the second spring arm.

Further, the first spring arm and the second spring aim are made of Ni—Ti based memory metal for increasing the lifespan.

Another object of the present invention is to provide a removable artificial tooth, which comprises an internal crown and an external crown. The internal crown is adapted to mount to a natural tooth and having a surface forming a projection block. The external crown comprises a spring clip fixed therein to correspond, in position, to the projection block. The spring clip comprises a first spring arm and a second sprig arm. The first spring arm has an end forming a first fixed end and an opposite end forming a first movable end, wherein the first fixed end is fixed inside an external crown. The second spring arm has an end forming a second fixed end and an opposite end forming a second movable end, wherein the second fixed end is fixed inside the external crown. Further, the first movable end and the second movable end are spaced from each other by a distance that is less than width of the projection block, whereby when the external crown is pressed down to fit over the internal crown, the first movable end and the second movable end are expanded outward by the projection block to allow the projection block to get into the space between the first spring arm and the second spring arm. When the external crown is fit in a direction from upper side to lower side to the internal crown, the spring clip is expanded by the projection block and after the projection block completely passes through the opening, the spring clip retains and constrains the position of the projection block.

Further, a further object of the present invention is to provide a removable artificial tooth for working with a projection block formed on a surface of a neighboring tooth, comprising: an external crown, which is adjacent to the neighboring tooth and has an adjacent surface to which a spring clip is provided. The spring clip corresponds in position to the projection block. The spring clip comprises a first spring arm, which has an end forming a first fixed end and an opposite end forming a first movable end, wherein the first fixed end is fixed inside an external crown; and a second spring arm, which has an end forming a second fixed end and an opposite end forming a second movable end, wherein the second fixed end is fixed inside the external crown. The first movable end and the second movable end are spaced from each other by a distance that is less than width of the projection block, whereby when the external crown is placed downward at a predetermined position, the first movable end and the second movable end are expanded outward by the projection block to allow the projection block to get into the space between the first spring arm and the second spring arm The control unit could have an input connector (e.g., an USB connector) for loading digital audio files into a non-volatile storage of the control unit.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing the assembling of internal and external crown according to an embodiment of the present invention.

FIG. 2 is a cross-sectional view of the assembled internal and external crowns.

FIGS. 3-5 are schematic view illustrating an operation of the embodiment of the present invention.

FIGS. 6-15 are schematic view showing configurations of embodying the spring clip according to the present invention.

FIG. 16 is a schematic view showing the present invention applied to a plurality of internal crowns.

FIG. 17 is a cross-sectional view showing the present invention applied to a plurality of internal crowns.

FIG. 18 is a schematic view showing the position of another embodiment.

FIG. 19 is a cross-sectional view showing another embodiment.

FIG. 20 is a front view showing another embodiment of the present invention.

FIG. 21 is a cross-sectional view of the embodiment shown in FIG. 19.

FIG. 22 is an exploded view showing an embodiment of the present invention that comprises a retention block and a resilient sleeve.

FIG. 23 is a perspective view showing the embodiment of the present invention that comprises the retention block and the resilient sleeve that are shown in a coupled condition.

FIG. 24 is a partial cross-sectional view of the embodiment shown in FIG. 22 that comprises the retention block and the resilient sleeve that are shown in the coupled condition.

FIG. 25 is an exploded view showing an embodiment of the present invention that is mounted to opposite sides of an outer crown.

FIG. 26 is a perspective view showing the embodiment of the present invention that is mounted to opposite sides of an outer crown in an assembled form.

FIG. 27 is an exploded view showing an embodiment of the present invention that comprises two spring clips arranged inside an outer crown.

FIG. 28 is a perspective view showing the embodiment of the present invention that comprises two spring clips arranged inside an outer crown in an assembled form.

FIG. 29 is a schematic view illustrating a thick pad is applied to fill a space formed in a neighboring tooth.

FIG. 30 is a cross-sectional view illustrating the thick pad is applied to fill a space formed in a neighboring tooth.

FIG. 31 is an exploded view showing an artificial tooth comprising extension arms and spring clips at two sides thereof.

FIG. 32 is a perspective view of FIG. 31 in an assembled form.

FIG. 33 is a cross-sectional view of FIG. 31 in the assembled form.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

To allow those having ordinary skills of the art the quickly understand embodiments of the present invention, explanation will be first made to a spring clip 1 combined to an external crown B of a withdrawable artificial tooth, as well as the operational relationship thereof with an internal crown A. Further, a projection block A1, the external crown B, and the spring clip 1 that are shown in the drawings are arranged according to a predetermined scale that is generally not limitative and can be adjusted as desired.

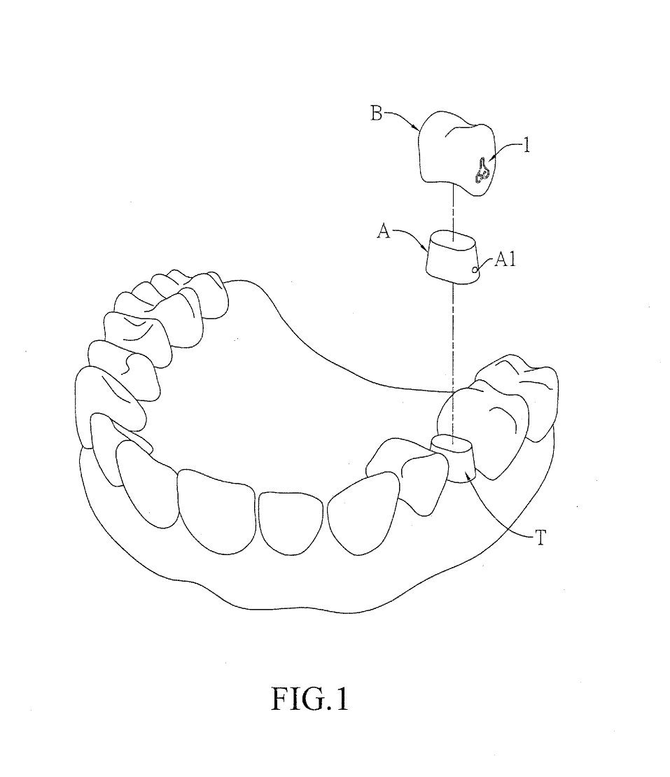

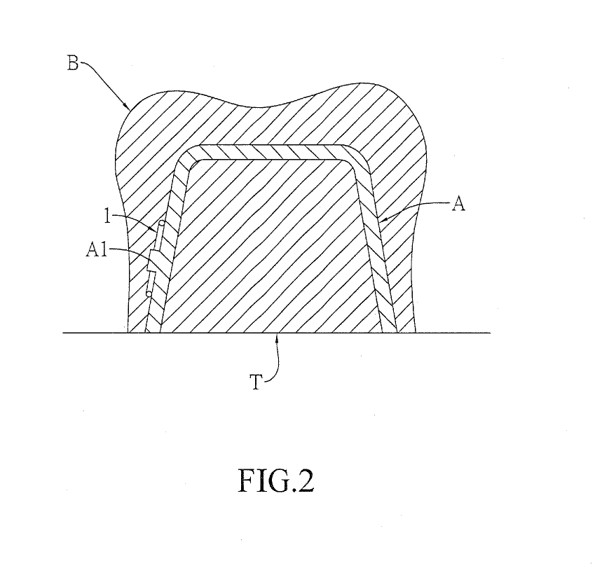

Referring to FIG. 1, which is a schematic view illustrating mounting of a removable artificial tooth, an internal crown A is mounted to a natural tooth T and an external crown B is fit to the internal crown A. The external crown B comprises therein a spring clip 1 that is engageable with and is coupled to the projection block A1. Across-sectional view showing the assembled condition is illustrated in FIG. 2. As such, the external crown B can be securely fixed, but the external crown B is still removable for cleaning. The structure will be described.

As shown in FIGS. 1-3, a removable artificial tooth according to the instant embodiment comprises an internal crown A and an external crown B. The internal crown A is mounted to a natural tooth T and has a surface forming a projection block A1. The external crown B comprises a spring clip 1 fixed therein to correspond, in position, to the projection block A1.

The spring clip 1 comprises a first spring arm 11 and a second spring arm 12. The first spring arm 11 has an end forming a first fixed end 111 and an opposite end forming a first movable end 112. The first fixed end 111 is fixed inside the external crown B. The second spring arm 12 has an end forming a second fixed end 121 and an opposite end forming a second movable end 122. The second fixed end 121 is fixed inside the external crown B. Further, the first movable end 112 and the second movable end 122 are spaced from each other by a distance that is slightly less than width of the projection block A1. Further, when the external crown B is pressed down to fit over the internal crown A, the first movable end 112 and the second movable end 122 are expanded outward by the projection block A1 to allow the projection block A1 to get into the space between the first spring arm 11 and the second spring arm 12. After the projection block A1 completely passes through the first movable end 112 and the second movable end 122, the spring clip 1 retains and constrains the position of the projection block A1.

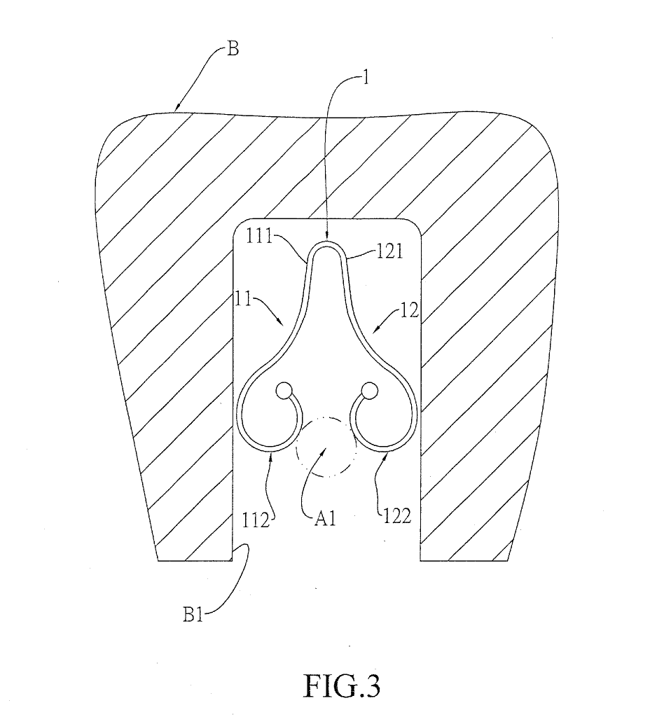

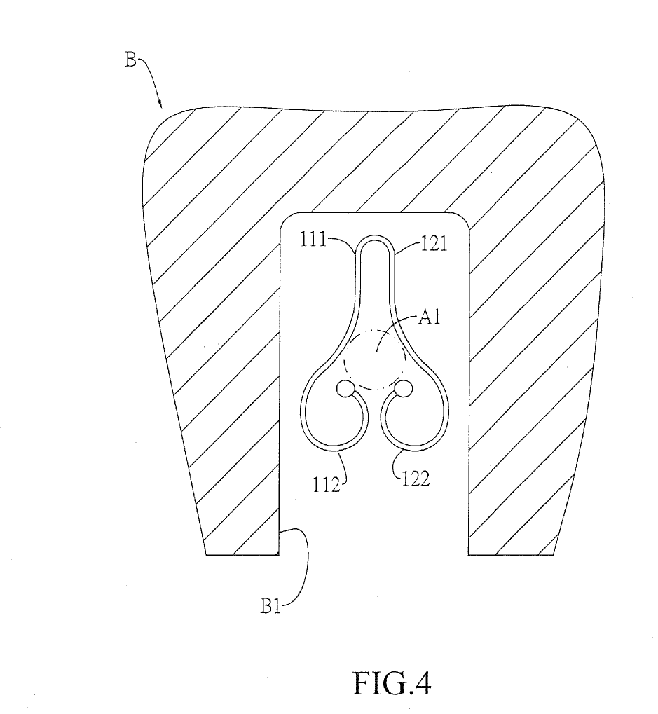

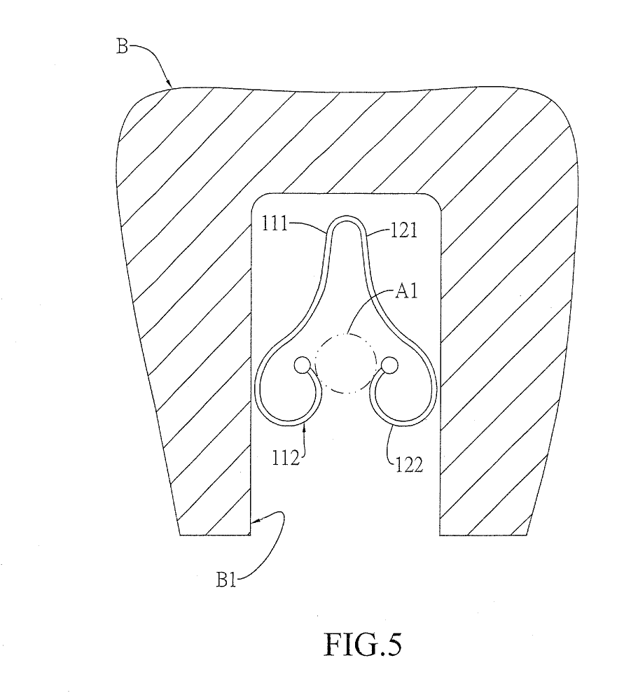

As shown in FIG. 4, with the cooperative engagement between the spring clip 1 and the projection block A1, when the external crown B is fit to the internal crown A, the spring clip 1 clamps the projection block A1, making relative position between the external crown B and the internal crown A fixed. To remove the external crown B, the external crown B is forcibly pulled upward, as shown in FIG. 5, to have the projection block A1 removed out of the space between the first movable end 112 and the second movable end 122 to exhibit a condition illustrated in FIG. 3, whereby the spring clip 1 no longer clamps the projection block A1 and the external crown B can be easily detached. For an actual operation, to provide a user an easy means to observe an insertion direction of the external crown B, a fool-proof structure may be provided. Further, in the instant embodiment, a single spring clip 1 is shown inside the external crown, yet is a practical application, a plurality of spring clips 1 may be used to respectively correspond to a plurality of projection blocks A1. This is a simple expansion of the inventive idea of the present invention and no repeated description will be given.

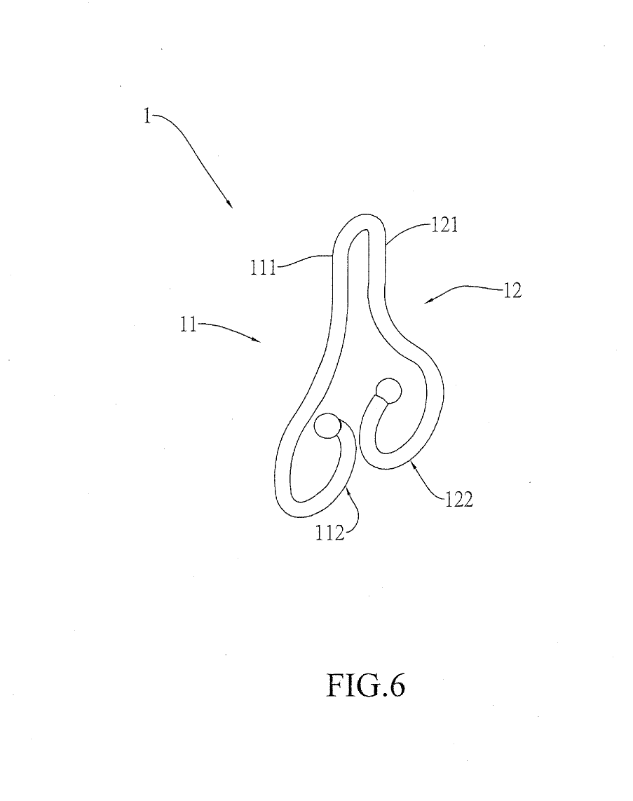

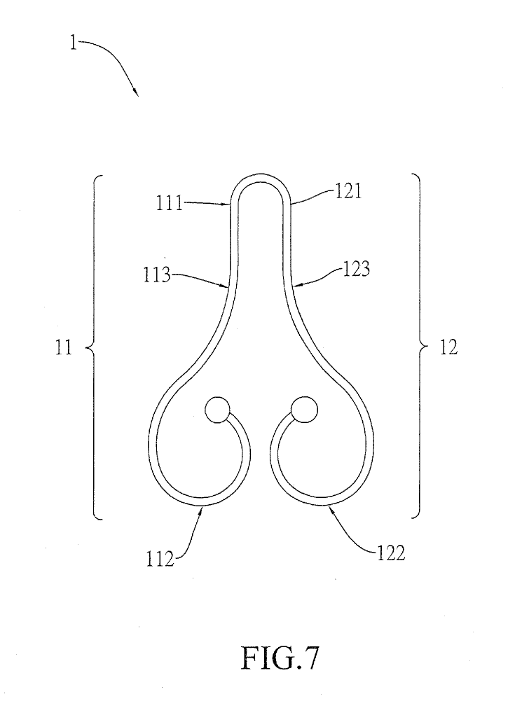

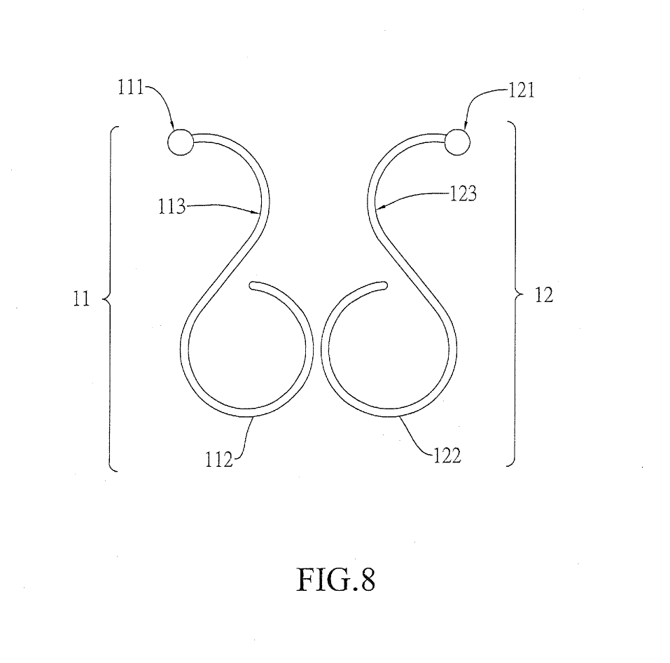

Referring to FIGS. 6 and 7, a first neck 113 is formed between the first fixed end 111 and the first movable end 112 and a second neck 123 is formed between the second fixed end 121 and the second movable end 122, whereby the first neck 113 and the second neck 123 are opposite to each other in position. The first neck 113 and the second neck 123 are spaced from each other by a distance that is less than the size of the projection block A1, whereby the projection block A1 is not allowed to expand outward the first neck 113 and the second neck 123. FIG. 8 shows another configuration of this type of arrangement.

Still referring to FIGS. 6 and 7, the first movable end 112 is formed by curving inward from the first spring arm 11 and the second movable end 122 is formed by curving inward from the second spring arm 12. This forms rounded corners that allows the projection block A1 to slide with respect to and over the first movable end 112 and the second movable end 122. Further, the first fixed end 111 and the second fixed end 121 can be directly fixed to each other so as to provide the spring clip 1 with improved elasticity and make mounting thereof easy.

As shown in FIG. 8, the first movable end 112 and the second movable end 122 are respectively set to extend outward to form auxiliary legs 1121, 1221 to provide assisting means that guides a projection C1 into the space between the first movable end 112 and the second movable end 122.

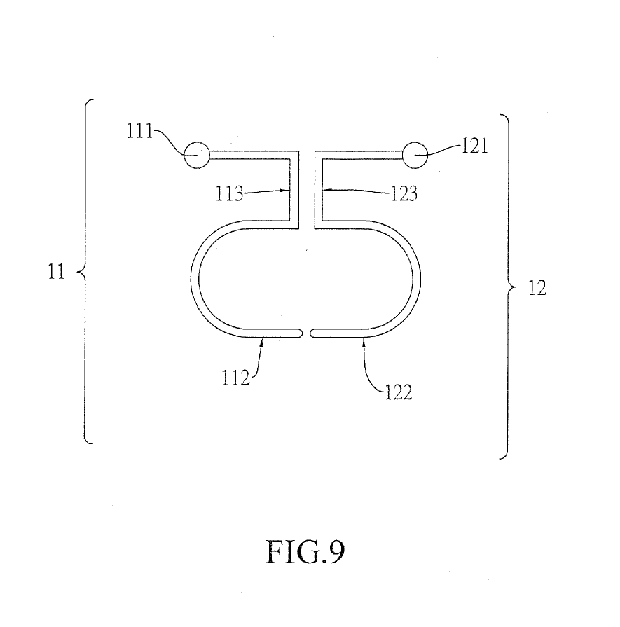

Referring to FIG. 9, a curve is formed between the first movable end 112 and the first neck 113 and a curve is also formed between the second movable end 122 and the second neck 123, wherein openings of the two curves are set opposing each other to allow the projection block A1 that passes through the first movable end 112 and the second movable end 122 to enter a space formed between the two opposing curves. This also retains and constrains the position of the projection block A1 and achieve the purposes of assembling the internal crown A and the external crown B. Further, the curved sections also help restorability of resiliency to improve the elasticity of the first movable end 112 and the second movable end 122.

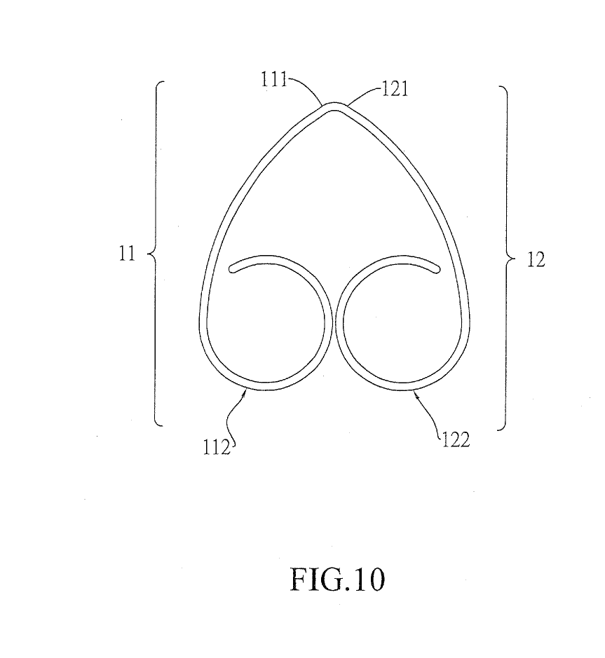

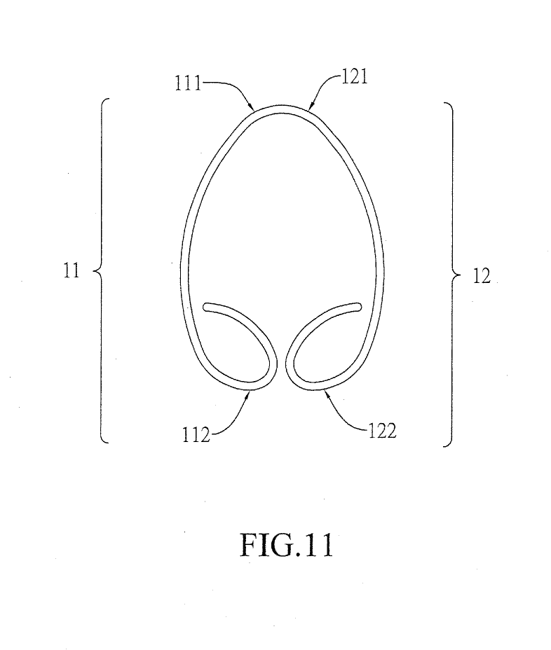

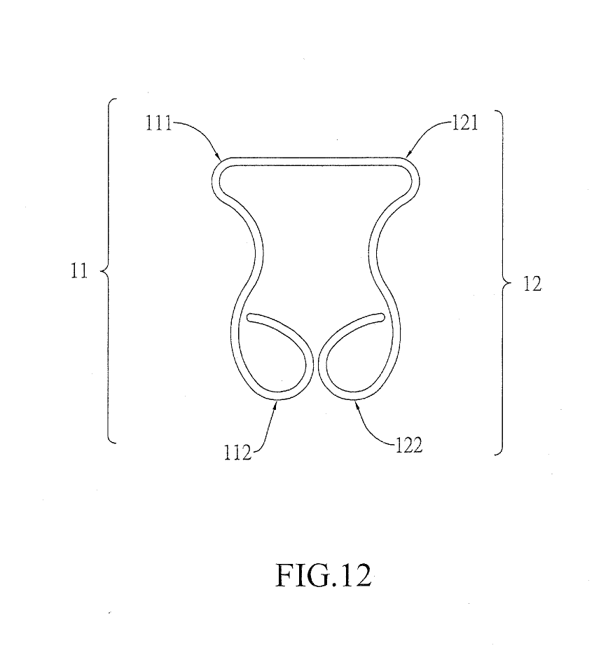

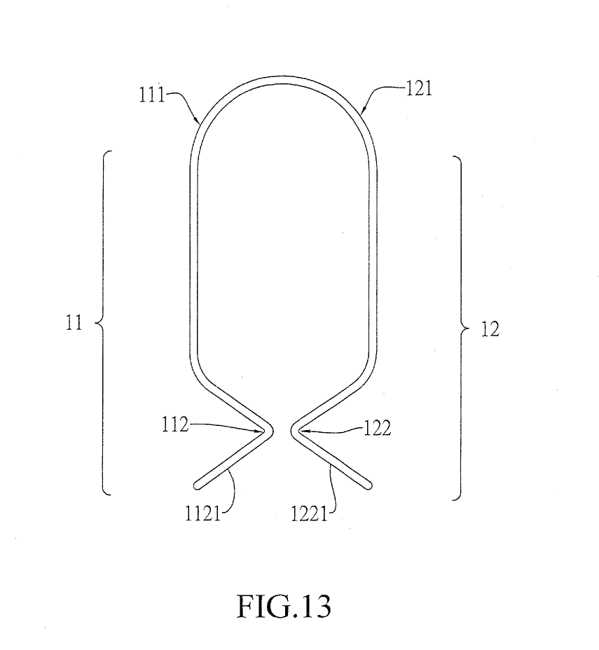

Further, as shown in FIGS. 10-12, the first movable end 112 and the second movable end 122 can be formed by inward curving so that smooth configurations are shown to help guiding the projection block A1 into the space between the first movable end 112 and the second movable end 122.

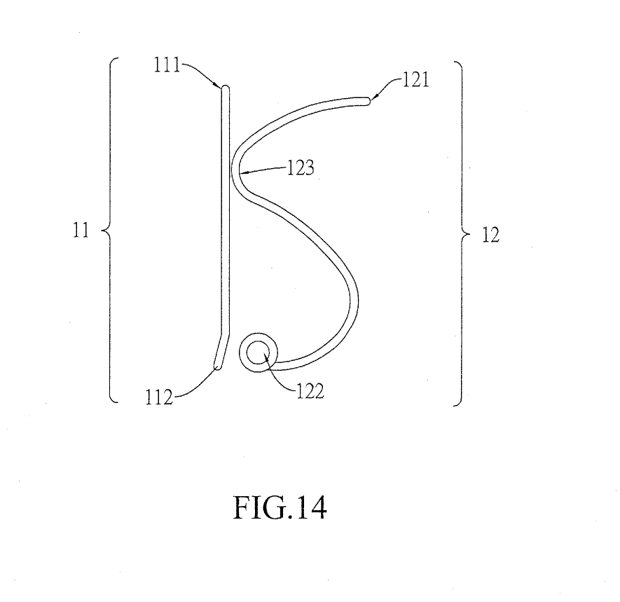

In another configuration of the spring clip 1 illustrated in FIG. 14, the first spring arm 11 is linear but shows a slight outward bend at the first movable end 112. A second neck 123 is formed between the second fixed end 121 and the second movable end 122. The second neck 123 and the first spring arm 11 are spaced from each other by a distance that is less than the size of the projection block A1 to prohibit the projection block A1 from passing through the second neck 123. Further, a curve is formed between the second movable end 122 and the second neck 123. The curve has an opening that opposes the first spring arm 11. With such a curve, the restorability of resiliency of the second movable end 122 can be improved. Further, the second movable end 122 is formed by inward curving from the second spring arm 12. This configuration of the spring clip is fit to a slim natural tooth. As such, the purposes and the advantages of the present invention can be achieved.

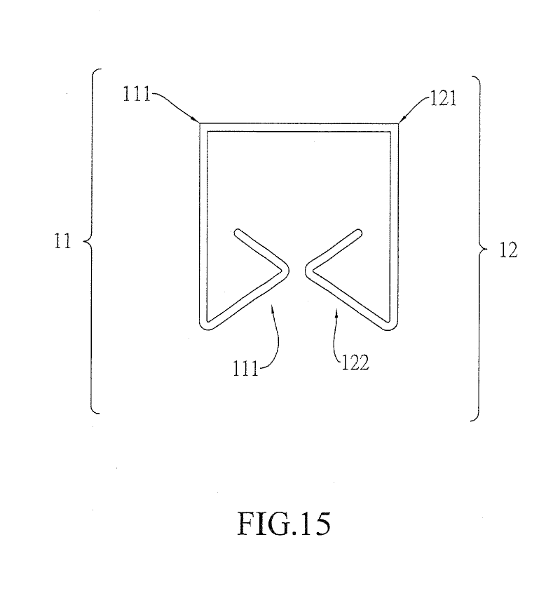

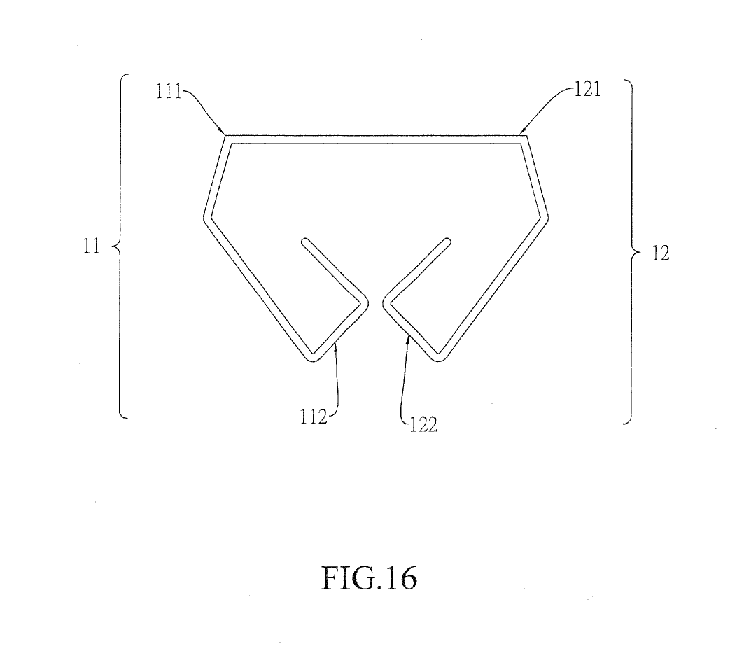

As shown in FIGS. 15 and 16, the first movable end 112 is formed by inward bending the first spring aim 11 twice. Each bending is made by an angle less than 90 degree and greater than 0 degree. The second movable end 122 is made opposite to the first movable end 112 and is formed by inward bending the second spring arm 12 twice with each bending being made by an angle less than 90 degrees and greater than 0 degree. One of the bends of the first spring arm 11 is made abutting against one of the bends of the second spring arm 12. As such, when the external crown is fit to the internal crown, the projection block A1 can be guided to fast pass between the first movable end 112 and the second movable end 122.

As shown in FIG. 3, the external crown B forms therein a groove B1 for receiving the spring clip 1. The groove B1 has a spacing that is less than width of adjacent face of the internal crown A. As such, the external crown B and the internal crown A keep the engagement surface at the surface and this protects the spring clip 1 and maintain engagement with the engagement surface to allow the capability of the external crown B and the internal crown A for bearing force not to be affected.

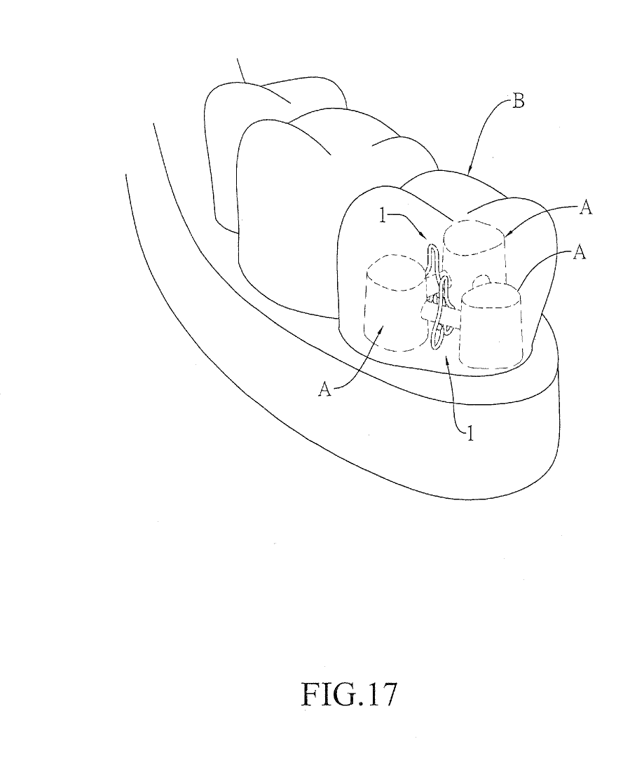

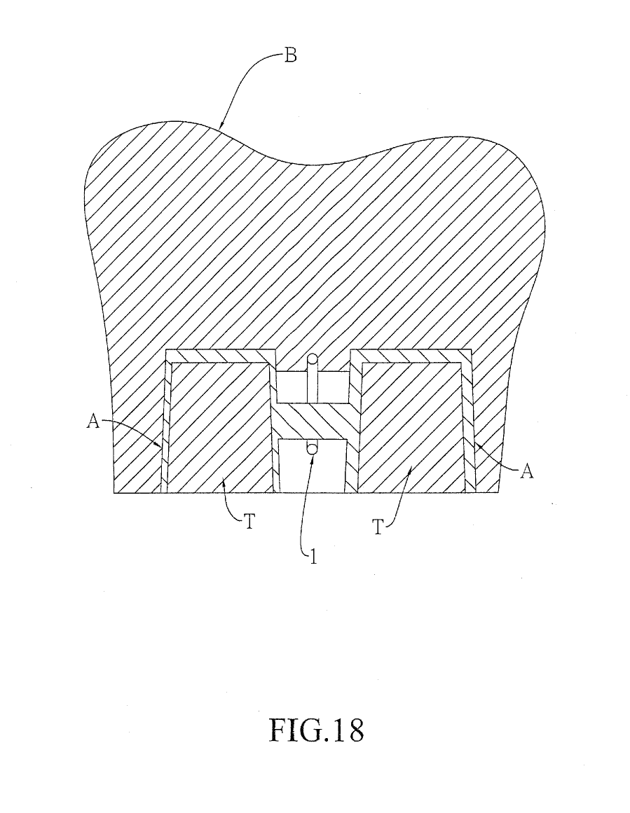

Referring to FIGS. 17 and 18, the internal crown B uses a projection block B1 to connect to another internal crown B (wherein the two internal crowns can be such that the internal crowns B are respectively fit to a plurality of natural teeth formed by dividing a single natural tooth and are connected to each other through the projection block), so that they can be arranged inside the external crown B to correspond to the positions of the projection blocks B1 to also achieve the advantage of the present invention.

Further, the first spring arm 11 and the second spring arm 12 can be made of Australia wire or Ni—Ti based memory metal to long maintain restorability of resilience.

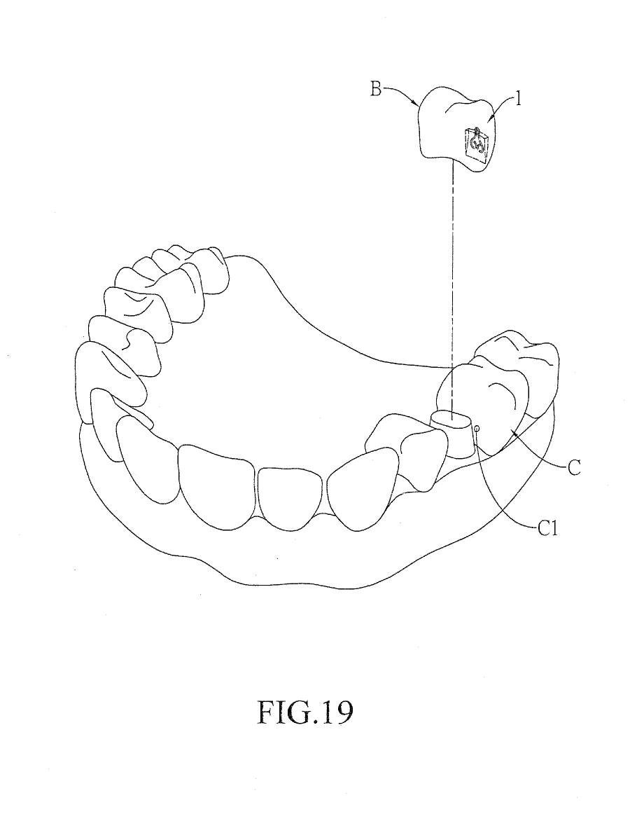

Referring to FIGS. 19-21, another embodiment of the removable artificial tooth according to the present invention is shown, wherein the spring clip 1 is arranged outside the external crown B to engage with and couple a projection C1 formed on a neighboring tooth C. Further, since the structure of the spring clip 1 is identical to the previous embodiment, those having ordinary skills in the art, after reading the description of the previous embodiment, can easily appreciate the instant embodiment. Thus, no repeated description will be given to the spring clip 1 and variations of the spring clip 1. Further, the projection C1 of the neighboring tooth C is formed by surface machining or adhesively bonding, or penetrating a pillar.

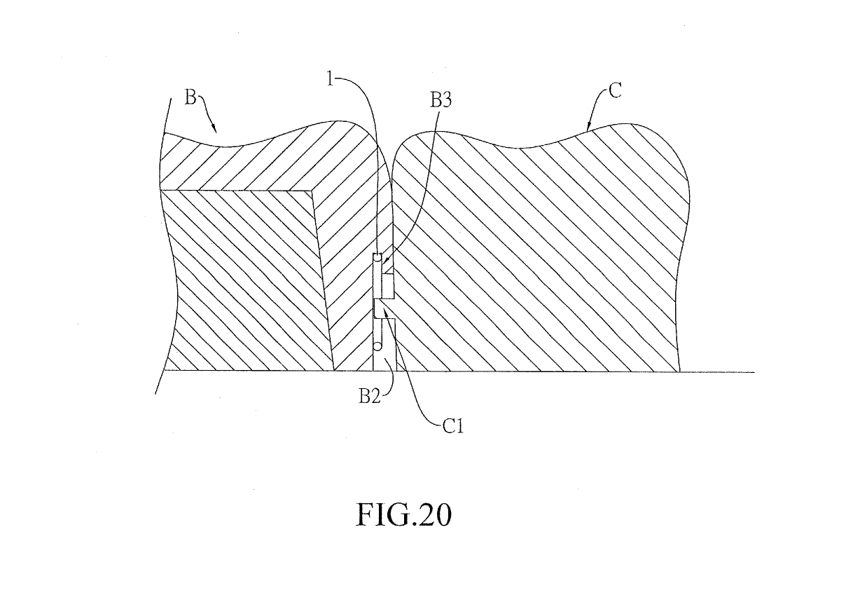

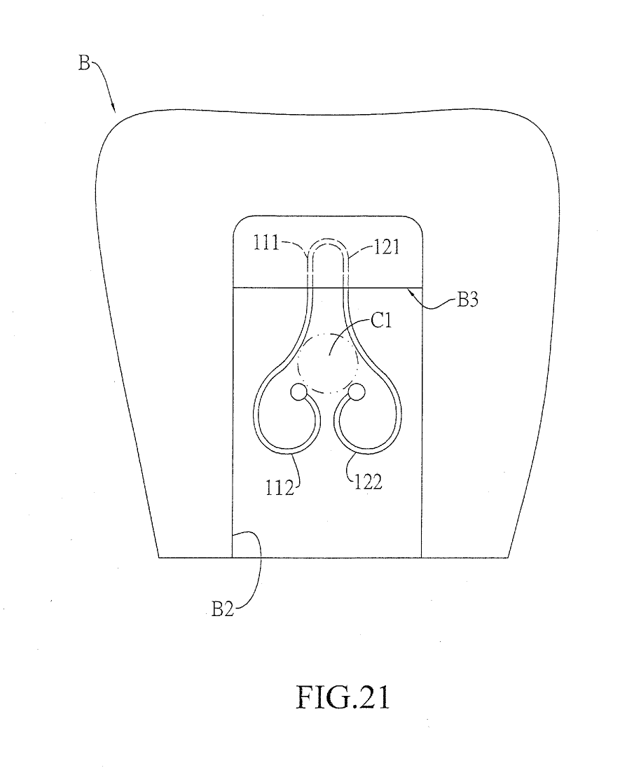

Further, as shown in FIGS. 20 and 21, a groove B2 is formed on a surface of the external crown B that is adjacent to the neighboring tooth C so that the gap between the external crown B and the neighboring tooth C can be reduced and the spring clip 1 is protected against skewing or detachment by an external impact in coupling the spring clip 1 and the projection C1. Further, the groove B2 has a top end in which a recessed slot B3 is formed to allow a top end of the spring clip 1 to be fixed in the recessed slot B3. The arrangement of the recessed slot B3 can help improving the convenience and stability of the spring clip 1. For example, adhesives can be filled into the recessed slot B3 in such a way that the adhesives fills up between the recessed slot B3 and a top end of the spring clip 1. As such, the top end of the spring clip 1 can be more securely fixed inside the recessed slot B3.

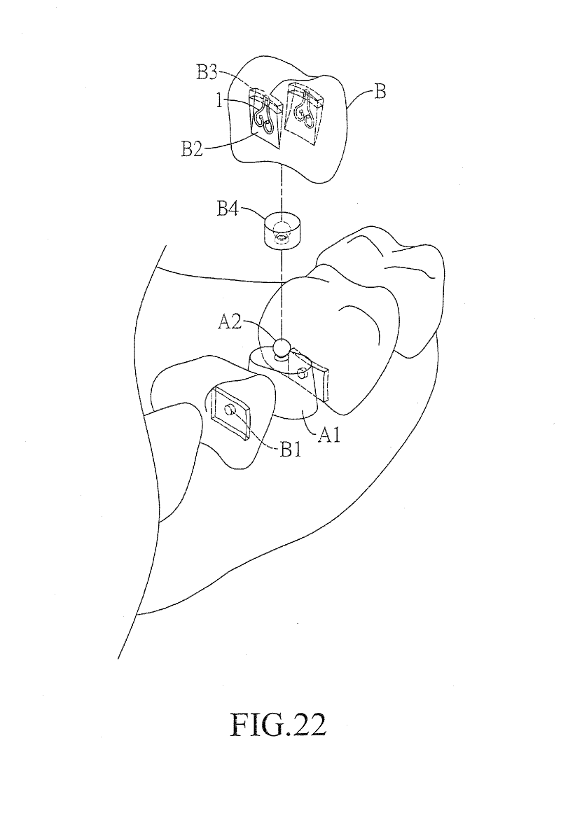

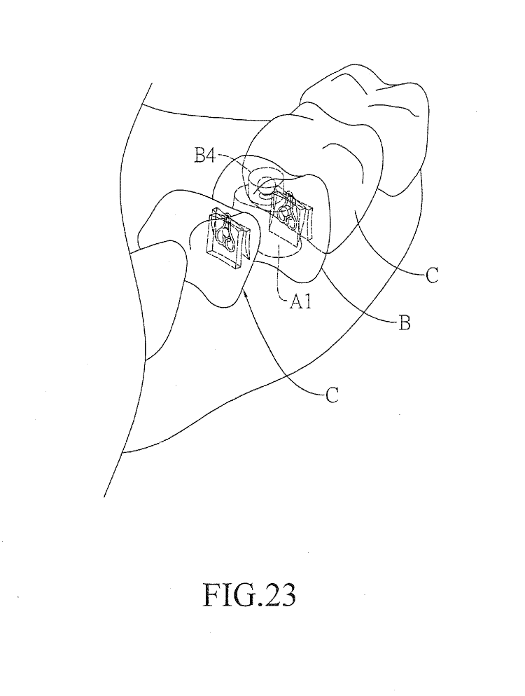

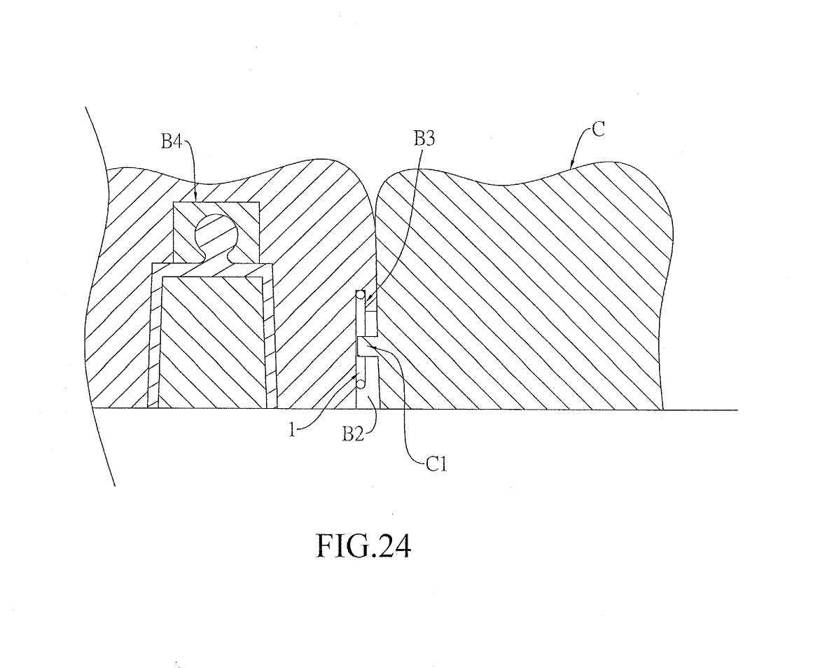

Referring to FIGS. 22-4, the internal crown Al is further provided with a retention block A2, and the external crown B is provided, at a position corresponding to the retention block A2, with a resilient sleeve B4. When the external crown B is fit to the internal crown A1, the resilient sleeve B4 resiliently encloses the retention block A2 so as to work with the spring clip 1 to make the relative position between the external crown B and the internal crown A1 more stable.

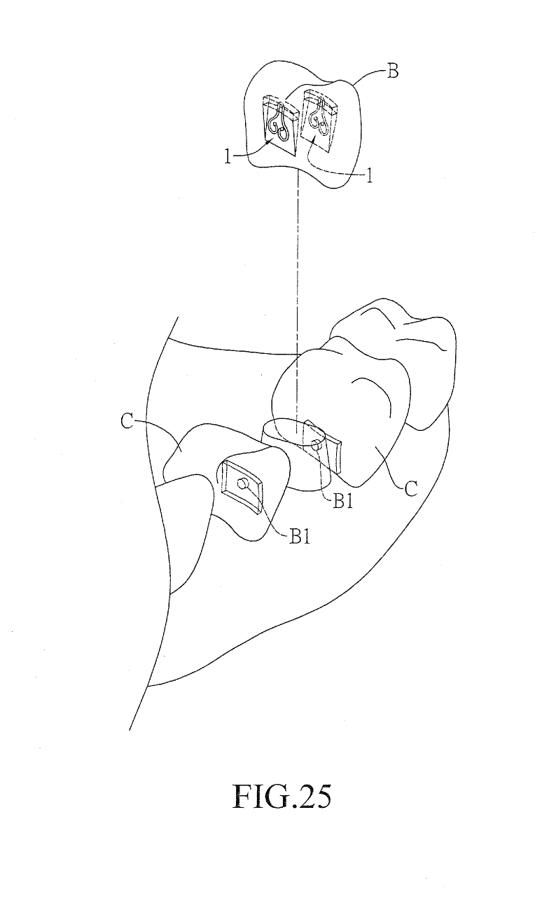

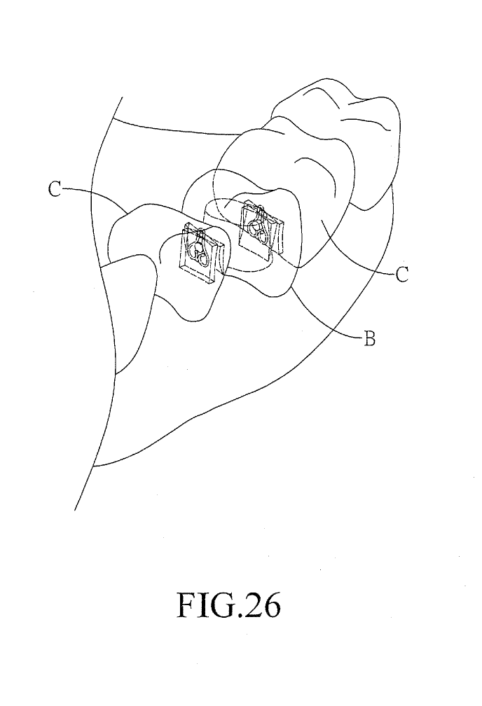

Further, as shown in FIGS. 25 and 26, the external crown B is provided with a spring clip 1 between the external crown and each of two neighboring teeth C and a projection block B1 is provided on each of the neighboring teeth, with such a more powerful force can be applied to chewing foodstuff.

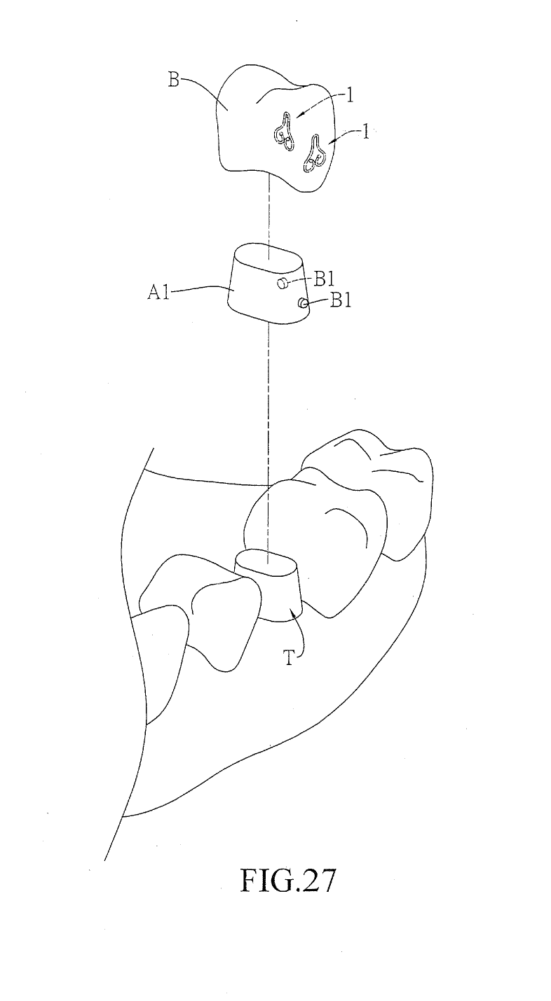

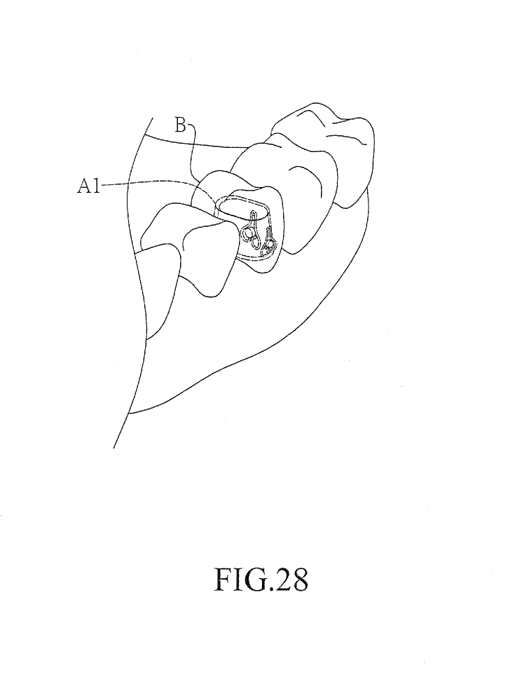

Referring to FIGS. 27 and 28, the internal crown Al is provided with two projection blocks B1 corresponding to the arrangement of two spring clips 1 for increasing the force can be born.

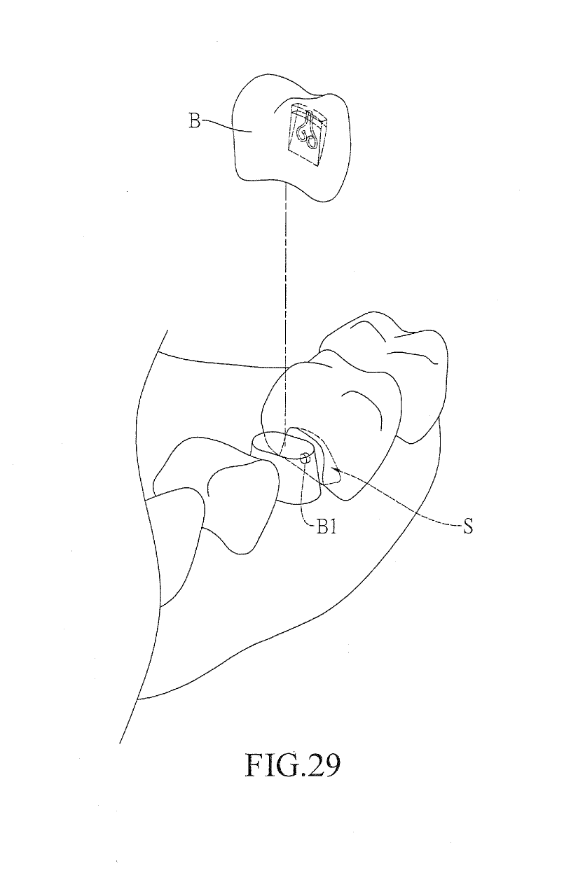

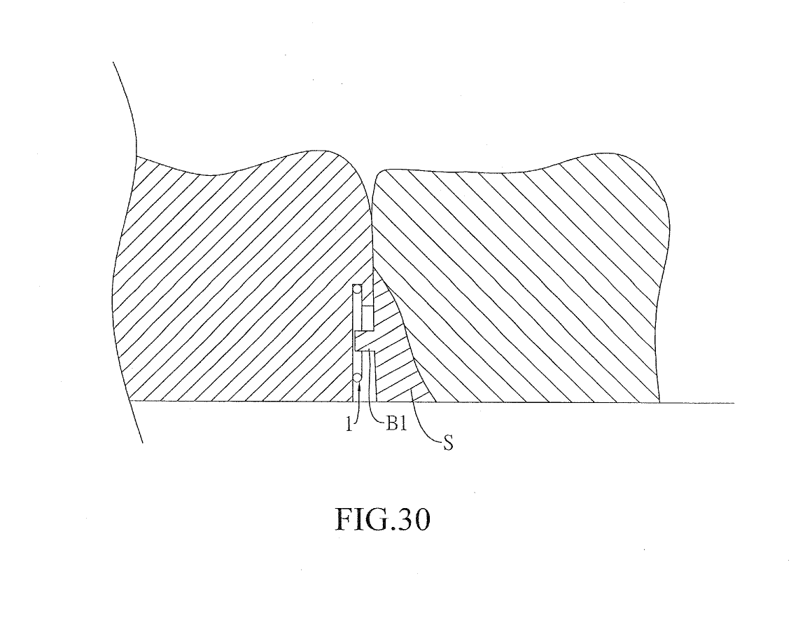

Further, as shown in FIGS. 29 and 30, when the neighboring tooth has a recess formed in a bottom section thereof and is relatively thin, which makes it not possible establish a projection block B1 with the method described above, as shown in these two drawings, a thick pad S is attached to allow the projection block B1 to be directly formed on the pad to handle this issue.

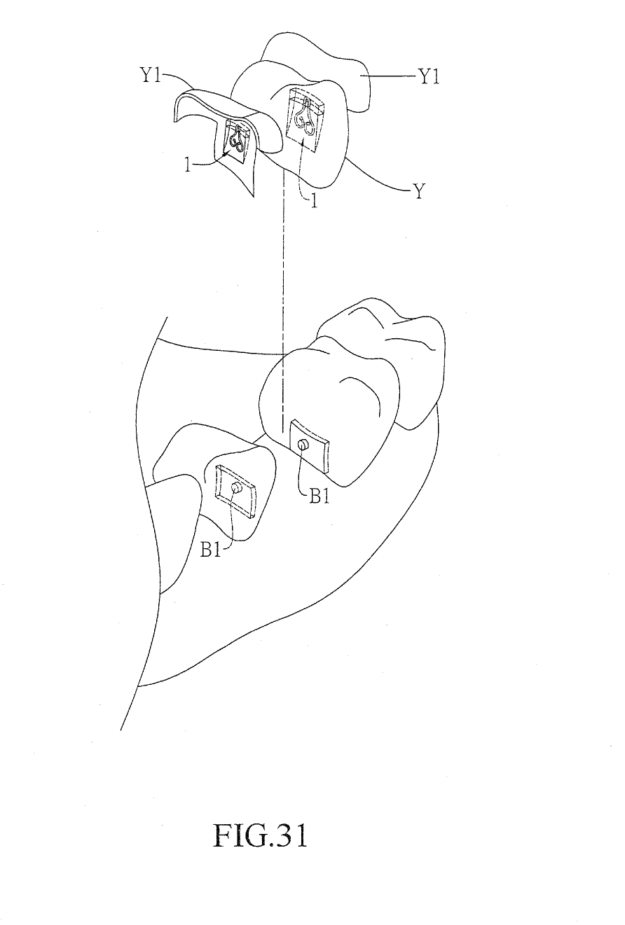

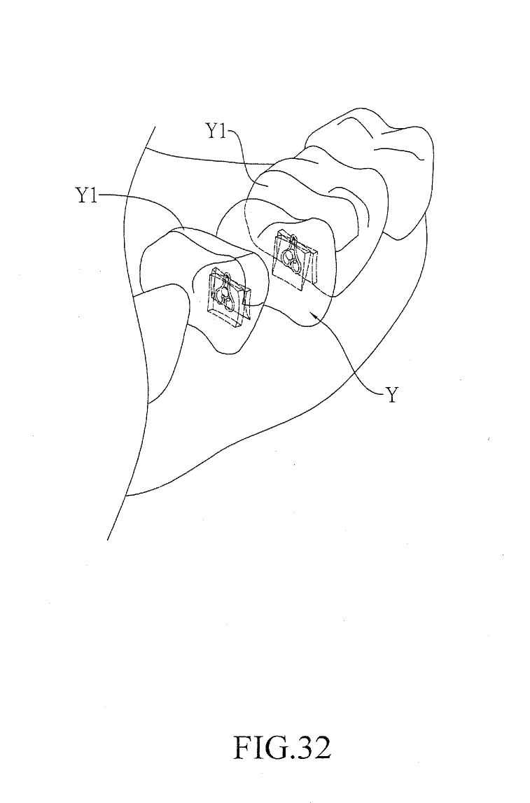

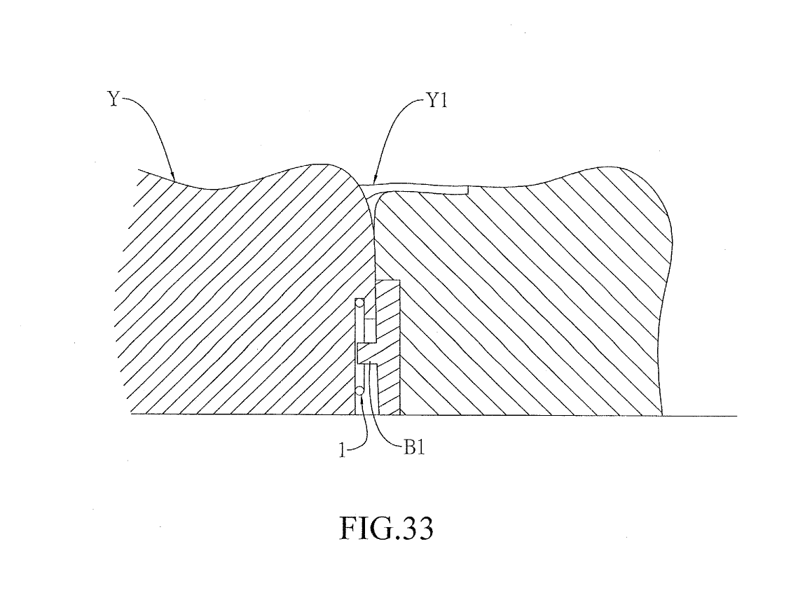

Further, as shown in FIGS. 31-33, the present invention is applicable to an artificial tooth Y with no internal crown. The artificial tooth Y forms an extension arm Y1 thereon at one side adjacent to a neighboring tooth. The extension arm is set to abut against the front face, the rear face, and the top face of the neighboring tooth so that the neighboring tooth may share the force acting on the artificial tooth. Further a spring clip 1 is provided to the artificial tooth at each side thereof adjacent to two neighboring teeth and a projection block B1 is formed on each of the neighboring teeth to provide a more powerful force for chewing foodstuff

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A spring clip mountable to withdrawable artificial tooth for clamping a projection block formed on an internal crown or a neighboring tooth, comprising:
a first spring arm, which has an end forming a first fixed end and an opposite end forming a first movable end, wherein the first fixed end is fixed inside an external crown; and
a second spring arm, which has an end forming a second fixed end and an opposite end forming a second movable end, wherein the second fixed end is fixed inside the external crown;
wherein the first movable end and the second movable end are spaced from each other by a distance that is less than width of the projection block, whereby when the external crown is pressed down to fit over the internal crown, the first movable end and the second movable end are expanded outward by the projection block to allow the projection block to get into the space between the first spring arm and the second spring arm.

2. The spring clip mountable to withdrawable artificial tooth according to claim 1, wherein a first neck is formed between the first fixed end and the first movable end and a second neck is formed between the second fixed end and the second movable end, whereby the first neck and the second neck are opposite to each other in position, the first neck and the second neck being spaced from each other by a distance that is less than size of the projection block so that the projection block is not allowed to expand outward the first neck and the second neck.

3. The spring clip mountable to withdrawable artificial tooth according to claim 2, wherein the first movable end is formed by curving inward from the first spring arm and the second movable end is formed by curving inward from the second spring arm.

4. The spring clip mountable to withdrawable artificial tooth according to claim 2, wherein a curve is formed between the first movable end and the first neck and a curve is also formed between the second movable end and the second neck, whereby openings of the two curves are set opposing each other to allow the projection block that passes through the first movable end and the second movable end to enter a space formed between the two opposing curves.

5. The spring clip mountable to withdrawable artificial tooth according to claim 2, wherein the first fixed end and the second fixed end are connected to each other.

6. The spring clip mountable to withdrawable artificial tooth according to claim 1, wherein the first spring arm is linear and a second neck is formed between the second fixed end and the second movable end, the second neck and the first spring arm being spaced from each other by a distance that is less than size of the projection block to prohibit the projection block from passing through the second neck, a curve being formed between the second movable end and the second neck, the curve having an opening that opposes the first spring arm, the second movable end being formed by inward curving the second spring arm.

7. The spring clip mountable to withdrawable artificial tooth according to claim 1, wherein the first movable end is formed by inward bending the first spring arm twice, each bending being made by an angle less than 90 degree and greater than 0 degree, the second movable end being made opposite to the first movable end and being formed by inward bending the second spring arm twice with each bending being made by an angle less than 90 degrees and greater than 0 degree, one of the bends of the first spring arm being made abutting against one of the bends of the second spring arm.

8. The spring clip mountable to withdrawable artificial tooth according to claim 1, wherein the first movable end and the second movable end are respectively set to extend outward to form auxiliary legs.

9. The spring clip mountable to withdrawable artificial tooth according to claim 1, wherein the first spring arm and the second spring arm 12 are made of Australia wire or Ni—Ti based memory metal.

10. A removable artificial tooth, comprising:
an internal crown, which is adapted to mount to a natural tooth and having a surface forming a projection block;
an external crown, which comprises a spring clip fixed therein to correspond, in position, to the projection block, the spring clip comprising:
a first spring arm, which has an end forming a first fixed end and an opposite end forming a first movable end, wherein the first fixed end is fixed inside an external crown; and
a second spring arm, which has an end forming a second fixed end and an opposite end forming a second movable end, wherein the second fixed end is fixed inside the external crown;
wherein the first movable end and the second movable end are spaced from each other by a distance that is less than width of the projection block, whereby when the external crown is pressed down to fit over the internal crown, the first movable end and the second movable end are expanded outward by the projection block to allow the projection block to get into the space between the first spring arm and the second spring arm;
whereby when the external crown is fit in a direction from upper side to lower side to the internal crown, the spring clip is expanded by the projection block and after the projection block completely passes through the first movable end and the second movable end, the spring clip retains and constrains the position of the projection block.

11. The removable artificial tooth according to claim 10, wherein the external crown forms therein a groove for receiving the spring clip, the groove having a spacing that is less than width of adjacent face of the internal crown.

12. The removable artificial tooth according to claim 11, wherein the internal crown uses a projection block to connect to another internal crown.

13. A removable artificial tooth for working with a projection block formed on a surface of a neighboring tooth, comprising:
an external crown, which is adjacent to the neighboring tooth and has an adjacent surface to which a spring clip is provided, the spring clip corresponding in position to the projection block, the spring clip comprising:
a first spring arm, which has an end forming a first fixed end and an opposite end forming a first movable end, wherein the first fixed end is fixed inside an external crown; and
a second spring arm, which has an end forming a second fixed end and an opposite end forming a second movable end, wherein the second fixed end is fixed inside the external crown;
wherein the first movable end and the second movable end are spaced from each other by a distance that is less than width of the projection block, whereby when the external crown is placed downward at a predetermined position, the first movable end and the second movable end are expanded outward by the projection block to allow the projection block to get into the space between the first spring arm and the second spring arm.

14. The removable artificial tooth according to claim 13, wherein the external crown forms in an outside thereof a groove for receiving the spring clip, the groove having a spacing less than width of adjacent face of the internal crown, the groove having a top end forming a recessed slot for receiving a top end of the spring clip.

15. The removable artificial tooth according to claim 14, wherein an internal crown to which the external crown is fit is further provided with a retention block and the external crown is provided, at a position corresponding to the retention block, with a resilient sleeve, whereby when the external crown is fit to the internal crown, the resilient sleeve resiliently encloses the retention block.

16. The removable artificial tooth according to claim 15, wherein the external crown is provided, at one side adjacent to the neighboring tooth, with an extension arm for abutting against the neighboring tooth.

17. The removable artificial tooth according to claim 16, wherein the extension arm is engageable with top face, front face, and rear face of the neighboring tooth.

18. A removable artificial tooth for working with a projection block formed on a surface of a neighboring tooth, comprising:
an artificial tooth, which is adjacent to the neighboring tooth and having an adjacent surface to which a spring clip is provided, the spring clip corresponding, in position, to the projection block, the spring clip comprising:
a first spring arm, which has an end forming a first fixed end and an opposite end forming a first movable end, wherein the first fixed end is fixed inside an external crown; and
a second spring aim, which has an end forming a second fixed end and an opposite end forming a second movable end, wherein the second fixed end is fixed inside the external crown;
wherein the first movable end and the second movable end are spaced from each other by a distance that is less than width of the projection block, whereby when the external crown is pressed down to fit over the internal crown, the first movable end and the second movable end are expanded outward by the projection block to allow the projection block to get into the space between the first spring aim and the second spring arm.

19. The removable artificial tooth according to claim 18, wherein the external crown forms in an outside thereof a groove for receiving the spring clip, the groove having a spacing less than width of adjacent face of the internal crown, the groove having a top end forming a recessed slot for receiving a top end of the spring clip.

20. The removable artificial tooth according to claim 19, wherein an internal crown to which the external crown is fit is further provided with a retention block and the external crown is provided, at a position corresponding to the retention block, with a resilient sleeve, whereby when the external crown is fit to the internal crown, the resilient sleeve resiliently encloses the retention block.

21. The removable artificial tooth according to claim 20, wherein the external crown is provided, at one side adjacent to the neighboring tooth, with an extension arm for abutting against the neighboring tooth.

22. The removable artificial tooth according to claim 21, wherein the extension arm is engageable with top face, front face, and rear face of the neighboring tooth
